(19) United States
(12) Patent Application Publication
(10) Pub. No.: US 2018/0060884 A1
(43) Pub. Date: Mar. 1, 2018

(54) Vehicle Suspension Measurement System and Associated Methods

(71) Applicant: Wal-Mart Stores, Inc., Bentonville, AR (US)

(72) Inventors: Nicholaus Adam Jones, Fayetteville, AR (US); Robert James Taylor, Rogers, AR (US); Aaron James Vasgaard, Fayetteville, AR (US); Matthew Allen Jones, Bentonville, AR (US)

(21) Appl. No.: 15/621,775

(22) Filed: Jun. 13, 2017

Related U.S. Application Data
(60) Provisional application No. 62/379,978, filed on Aug. 26, 2016.

(51) Int. Cl. G06Q 30/02; G07C 5/00; G07C 5/08; G01B 11/14; G01G 19/02

(52) U.S. Cl. CPC G06Q 30/0201; G07C 5/008; G01G 19/024; G01B 11/14; G07C 5/08

(57) ABSTRACT

A vehicle suspension measurement system that allows for tracking of customer traffic at a retail environment, and for determining whether items were purchased by a customer during their visit to the retail environment is discussed. Using a passive sensor-based system, data may be gathered by visually analyzing a vehicle's suspension system upon entry to the retail environment and again upon exit from the retail environment. A comparison of the entry and exit images may be performed to determine the degree of engagement of the vehicle suspension system and thereby provide an indicator as to whether the customer in the vehicle has made a purchase.

### CROSS-REFERENCE TO RELATED APPLICATIONS

This application claims the benefit of co-pending, commonly assigned U.S. Provisional Patent Application No. 62/379,978, which was filed on Aug. 26, 2016. The entire content of the foregoing provisional patent application is incorporated herein by reference.

### BACKGROUND

Motor vehicles include suspension systems to smooth their ride characteristics to increase the comfort of passengers while also assisting with the vehicle's road handling and braking characteristics. The suspension systems typically include tires, springs, shock absorbers and related linkages oriented near the vehicle's wheels. Some vehicles have front suspensions and some have rear suspensions. In some vehicles, the suspension may be tuned mainly for the comfort of the passengers while in others the suspension may be tuned mainly to increase performance with the side effect of creating a harsher ride.

### SUMMARY

Exemplary embodiments of the present invention provide a vehicle suspension measurement system that allows for tracking of customer traffic at a retail environment, and for determining whether items were purchased by a customer during their visit to the retail environment. Using a passive sensor-based system, data may be gathered by visually analyzing a vehicle's suspension system upon entry to the retail environment and again upon exit from the retail environment. A comparison of the entry and exit images may be performed to determine the degree of engagement of the vehicle suspension system and thereby provide an indicator as to whether the customer in the vehicle has made a purchase. The duration of the customer visit to the retail environment may also be noted and stored in a database as part of an effort to increase knowledge of customer shopping patterns.

In one embodiment, an exemplary vehicle suspension measurement system includes one or more sensors, a processing device equipped with a processor, and a communication interface configured to enable communication between the one or more sensors and the processing device. The one or more sensors include a camera. The processing device can be configured to execute instructions to obtain one or more measurement values indicative of an entry suspension load of a vehicle taken by the one or more sensors upon entry of the vehicle into a predetermined geographic area. The processing device can also be configured to execute instructions to obtain one or more measurement values indicative of an exit suspension load of the vehicle taken by the one or more sensors upon exit of the vehicle from the predetermined geographic area. The processing device can further be configured to execute instructions to examine the one or more measurement values indicative of the entry suspension load and the one or more measurement values indicative of the exit suspension load to determine any differences. The processing device can be configured to execute instructions to determine that a purchase of at least one item at the retail environment associated with the predetermined geographic area has taken place when the one or more measurement values indicative of the exit suspension load value exceeds the one or more measurement values indicative of the entry suspension load value by a predetermined amount.

In an embodiment, an exemplary non-transitory computer-readable medium is provided that stores instructions for determining a change in suspension load of a vehicle. The instructions can be executable by a processing device. Execution of the instructions by the processing device can cause the processing device to obtain one or more measurement values indicative of an entry suspension load of a vehicle taken by one or more sensors upon entry of the vehicle into a predetermined geographic area. The one or more sensors include a camera. Execution of the instructions by the processing device can also cause the processing device to obtain one or more measurement values indicative of an exit suspension load of the vehicle taken by the one or more sensors upon exit of the vehicle from the predetermined geographic area. Additionally, execution of the instructions by the processing device can cause the processing device to examine the one or more measurement values indicative of the entry suspension load and the one or more measurement values indicative of the exit suspension load to determine any differences. Execution of the instructions by the processing device can cause the processing device to determine that a purchase of at least one item at a retail environment associated with the predetermined geographic area has taken place when the one or more measurement values indicative of the exit suspension load exceeds the one or more measurement values indicative of the entry suspension load by a predetermined amount.

In another embodiment, an exemplary method of determining a change in suspension load of a vehicle includes obtaining one or more measurement values indicative of an entry suspension load of a vehicle taken by one or more sensors upon entry of the vehicle into a predetermined geographic area. The one or more sensors include a camera. The method also includes obtaining one or more measurement values indicative of an exit suspension load of the vehicle taken by the one or more sensors upon exit of the vehicle form the predetermined geographic area. The method further includes examining the one or more measurement values indicative of the entry suspension load and the one or more measurement values indicative of the exit suspension load to determine any differences. A purchase of at least one item at a retail environment associated with the predetermined geographic area is determined to have taken place when the one or more measurement values indicative of the exit suspension load exceeds the one or more measurement values indicative of the entry suspension load by a predetermined amount.

It should be appreciated that combinations and/or permutations of embodiments is envisioned as being within the scope of the present invention. Other objects and features will become apparent from the following detailed description considered in conjunction with the accompanying drawings. It is to be understood, however, that the drawings are designed as an illustration only and not as a definition of the limits of the present disclosure.

### BRIEF DESCRIPTION OF THE DRAWINGS

To assist those of skill in the art in making and using the disclosed vehicle suspension measurement systems and associated methods, reference is made to the accompanying figures. The accompanying figures, which are incorporated in and constitute a part of this specification, illustrate one or more embodiments of the invention and, together with the description, help to explain the invention. In the figures:

FIG. 1 is a block diagram of an exemplary vehicle suspension measurement system in an embodiment.

FIG. 2 is a block diagram of an exemplary implementation of a sensor of a vehicle suspension measurement system in an embodiment.

FIG. 3 is a diagram of an exemplary measurement of an entry suspension load of a vehicle by a sensor of a vehicle suspension measurement system in an embodiment.

FIG. 4 is a diagram of an exemplary measurement of an exit suspension load of a vehicle by a sensor of a vehicle suspension measurement system in an embodiment.

FIG. 5 is a block diagram of a computing device in accordance with exemplary embodiments.

FIG. 6 is a block diagram of an exemplary vehicle suspension measurement system environment in an embodiment.

FIG. 7 is a flowchart illustrating an implementation of an exemplary vehicle suspension measurement system in an embodiment.

### DETAILED DESCRIPTION

Retail environments provide a variety of items for sale to customers. In general, a customer travels to a retail environment in a vehicle, and after purchasing one or more items at the retail environment, transports the purchased items in their vehicle. Understanding the number of vehicles traveling to and from the retail environment, as well as whether items were purchased by the customer during their visit to the retail environment, can be helpful in understanding customer traffic and improving sales.

Exemplary embodiments of the present invention allow for monitoring of consumer traffic at a retail environment, including the ability to determine the duration of customer visits, whether items were purchased, and an estimated weight of the purchased items, by providing a vehicle suspension measurement system. In particular, the exemplary system includes one or more sensors that measure the entry and exit suspension loads of vehicles entering a predetermined geographic area associated with the retail environment. Based on a difference in the exit and entry suspension loads, a determination can be made as to whether items were purchased by the customer. A vehicle database holding suspension characteristics of different types of vehicle suspensions may be used in the analysis. As discussed herein, an item can refer to anything purchased that results in a change in weight within the vehicle, such as products, grocery items, pharmacy items, gas for the vehicle, car repair or maintenance items, combinations thereof, or the like. Information related to the duration of customer/vehicle visits to the retail environment and the percentage of vehicles/customers that make a purchase during the visit may be gathered and stored for use by the retail environment. In one embodiment, based on the duration or frequency of visits to the retail environment, the number of items purchased and/or the weight of the items purchased, the exemplary system can be used to extend customized sales and/or offers (e.g., such as delivery services) to customers whose vehicles have been uniquely identified, thereby improving the overall customer experience. In one embodiment, video analytics may be used to uniquely identify the vehicle, such as by reading a license plate

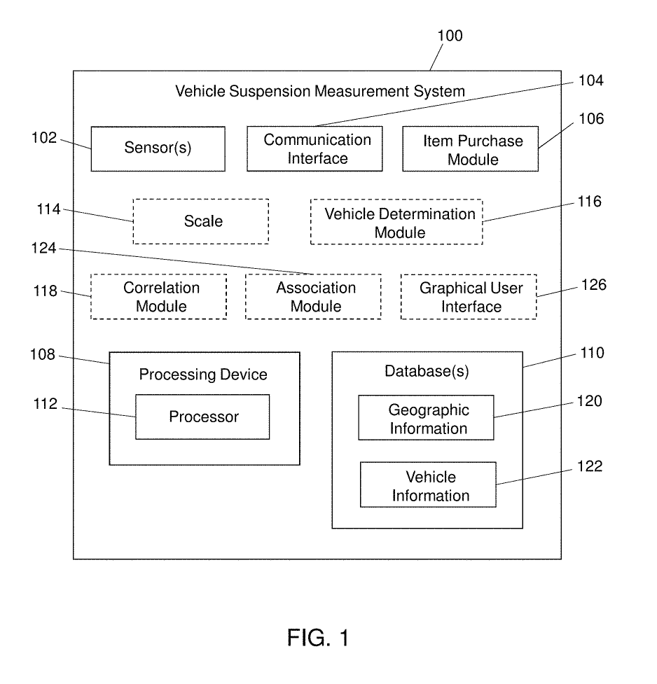

FIG. 1 is a block diagram of an exemplary vehicle suspension measurement system 100 (hereinafter “system 100”) in accordance with an embodiment. The system 100 generally includes one or more sensors 102, a communication interface 104, an item purchase module 106, a processing device 108, and one or more databases 110. The system 100 can be incorporated into a predetermined geographic area associated with a retail environment, such as a parking lot, a gas station area, a vehicle repair area, a pharmacy area, a grocery area, an item pick-up area, combinations thereof, or the like. For example, multiple sensors 102 can be distributed throughout the predetermined geographic area to monitor vehicle suspension loads associated with vehicles at each of the areas of the retail environment. Thus, changes in suspension load indicating item purchase can be determined based on the specific area of the retail environment, resulting in correlation between vehicles visiting the retail environment and the frequency of sales at specific areas of the retail environment.

In one embodiment, the sensors 102 can be in the form of video cameras disposed in one or more locations in the predetermined geographic area. For example, video cameras can be focused on substantially flat areas of entry and exit into a parking lot of the retail environment. When a vehicle enters the parking lot and passes through the substantially flat entrance portion, the sensor 102 can electronically obtain one or more measurement values indicative of the entry suspension load of the vehicle. In one embodiment, the entry suspension load measurement can be taken as a distance from a center of a wheel of the vehicle to the top of the wheel opening for the wheel in the body of the vehicle. In another embodiment, the entry suspension load measurement can be taken as a distance from the top of the wheel to an edge of the wheel opening for the wheel in the body of the vehicle.

After the customer has completed shopping at the retail environment, when the vehicle exits the parking lot and passes through a substantially flat exit portion, the sensor 102 (or an alternative sensor 102) can electronically obtain one or more measurement values indicative of the exit suspension load of the vehicle. Similar to the entry suspension load measurement, the exit suspension load measurement can be taken as a distance from the center of the wheel of the vehicle to the top of the wheel opening for the wheel in the body of the vehicle or can be taken from the top of the wheel to the edge of the wheel opening in the body of the vehicle. It will be appreciated that whatever technique was used to measure the entry suspension load should be used to measure the exit suspension load so that comparisons may be accurately made. In one embodiment, the entry and exit suspension load measurements can be taken for each of the wheels of the vehicle, thereby allowing for measurement of changes in load distribution within the vehicle during entry and exit of the vehicle into the predetermined geographic area. If the customer has purchased one or more items at the retail environment and is transporting the items in the vehicle, the measured distance of the exit suspension load would be smaller than the measured distance of the entry suspension load, indicating a higher suspension load value on the vehicle due to the change in weight.

Upon obtaining the entry suspension load, the exit suspension load, or both, the obtained data can be electronically transmitted to the processing device 108. In particular, the communication interface 104 can be configured to enable electronic communication (e.g., wired and/or wireless) between the sensors 102 and the processing device 108. Thus, data obtained by the sensors 102 can be electronically transmitted to the processing device 108 via the communication interface 104. The processing device 108 can include a processor 112 configured to execute instructions to regulate actuation of the sensors 102 in order to obtain the entry and exit suspension load measurements. The processor 112 can further execute instructions to examine the obtained measurement values to determine any differences between the entry and exit suspension load.

In one embodiment, the system 100 can include an item purchase module 106. Although shown as a separate component, the item purchase module 106 can be incorporated into the processing device 108 and/or the processor 112. The item purchase module 106 (in collaboration with and/or by execution via the processor 112) can determine whether a purchase of at least one item has taken place at the retail environment. In particular, the item purchase module 102 can receive as input the entry suspension load measurement(s) for a vehicle, the exit suspension load measurement(s) for the vehicle, and a difference between the entry and exit suspension load measurements (if any). If the measured distance for the exit suspension load is smaller than the measured distance for the entry suspension load of the vehicle, the item purchase module 106 can correlate the difference in measured values to a higher exit suspension load value.

In particular, a larger entry suspension load measurement indicates a lighter vehicle at entry into the predetermined geographic area, and a smaller exit suspension load measurement indicates a heavier vehicle at exit from the predetermined geographic area. In one embodiment, if the difference in suspension load values exceeds a predetermined amount, the item purchase module 106 determines that one or more items have been purchased by the customer at the retail environment. In one embodiment, if the entry suspension load measurement is smaller than the exit suspension load measurement, the item purchase module 106 determines that one or more items previously purchased by the customer were returned to the retail environment (although it will be appreciated that the larger exit load measurement may also indicate fewer passengers in the vehicle when it is exiting than were in the vehicle when it arrived).

In one embodiment, the item purchase module 106 can determine the time period between measurement of the entry suspension load and measurement of the exit suspension load. Based on the duration of the vehicle visit to the retail environment (and/or the location of the sensor 102), the item purchase module 106 can estimate whether an item was purchased or whether the customer used an alternative service provided by the retail environment. For example, if the time period is under ten minutes and the difference in the measured suspension load is significantly different as measured prior to entry into a gas station area, the item purchase module 106 can determine that the customer filled the vehicle with gas and did not purchase other items at the retail environment.

In one embodiment, in addition to the sensors 102, the predetermined geographic area can include one or more scales 114 configured to measure the weight of the vehicle upon entry and exit from the predetermined geographic area. For example, scales 114 can be disposed at the entrance and exit points of the parking lot associated with the retail environment. Thus, weight of vehicles entering and exiting the parking lot can be measured to determine the difference in weight after customers have completed shopping at the retail environment. Weight data obtained by the scales 114 can be electronically transmitted to the processing device 108 via the communication interface 104, and correlated with the suspension load data collected by the sensors 102.

In one embodiment, the system 100 can include a vehicle determination module 116. Although illustrated as a separate component, in one embodiment, the vehicle determination module 116 can be incorporated into the processing device 108 and/or the processor 112. The vehicle determination module 116 can communicate with the sensors 102 via the communication interface 104 such that the sensors 102 can be actuated to capture vehicle identification information, e.g., a make of the vehicle, a model of the vehicle, a license plate number, combinations thereof, or the like. The captured vehicle identification information can be used by the vehicle determination module 116 to determine the city or a more specific address to which the vehicle is registered, thereby determining the distance driven by the customer to reach the retail environment. If a customer is determined to drive a long distance each week to the retail environment (e.g., a distance outside of a predetermined radius), the system 100 can be used to extend promotions and/or offers regarding delivery options to the residential address of the customer. In particular, the promotions and/or offers extended to the customer can be customized based on the needs of the customer.

In one embodiment, the system 100 can include a correlation module 118. Although illustrated as a separate component, in one embodiment, the correlation module 118 can be incorporated into the processing device 108 and/or the processor 112. The correlation module 118 can be executed by the processing device 108 to correlate the measured suspension load values with point-of-sale (POS) data collected at POS terminals in the retail environment. In particular, the system 100 can be communicatively connected to a separate system of the retail environment that maintains a record of the items purchased by customers at each of the POS terminals.

The correlation module 118 can correlate a specific vehicle with purchases made at a POS terminal based on the data collected by the vehicle determination module 116. For example, based on the license plate of the vehicle, the name of the person to whom the vehicle is registered can be determined and such information can be compared to customers who purchased items at the retail environment. If a match is located (e.g., by last name of customers), the correlation module 118 can correlate the purchases made with the proper vehicle. Further, the correlation module 118 can correlate the change in the measured suspension load with the estimated weight of the items purchased by the customer.

The data measured and/or generated by the system 100 can be electronically transmitted by the communication interface 104 to one or more databases 110 for storage. In one embodiment, the database 110 can be located within the retail environment. In one embodiment, the database 110 can be located at one or more remote servers outside of the retail environment. The database 110 can be used to store geographic information 120, e.g., the various predetermined geographic areas associated with the retail environment, the location of the sensors 102, the location of the scales 114, combinations thereof, or the like. The database 110 can be used to store vehicle information 122, e.g., information measured by the sensors 102, information measured by the scales 114, information generated by the vehicle determination module 116, information generated by the correlation module 118, determinations of whether items were purchased by customers, combinations thereof, or the like. In one embodiment, the database 110 may also hold suspension information for different types of vehicles. For example, database 110 may hold suspension information indicating how much weight is required to engage the suspension system a certain amount. This information may be used in interpreting the load on the vehicle when analyzing the entry suspension load and exit suspension load measurements.

In one embodiment, the system 100 can include an association module 124. Although illustrated as a separate component, in one embodiment, the association module 124 can be incorporated into the processing device 108 and/or the processor 112. The association module 124 can associate the geographic information 120 with the corresponding vehicle information 122 such that the system 100 outputs the frequency of visits of a customer to the retail environment, the purchases made by the customer at the retail environment during each visit, the size and/or weight of the items purchased by the customers during each visit, the distance traveled by the customer to reach the retail environment, and the like.

Based on such information, the system 100 can offer customized services to the customer associated with the respective vehicles. For example, if a customer is determined to travel long distances to reach the retail environment on a weekly basis, the system 100 can offer the customer delivery services. As a further example, if a customer is determined to frequently purchase large, heavy objects from the retail environment, the system 100 can offer the customer delivery services. As a further example, if a customer is determined to frequently travel to the retail environment for vehicle repair, the system 100 can offer the customer discounts for vehicle repair services. As a further example, if a customer is determined to purchase grocery items during each visit to the retail environment, the system 100 can offer the customer discounts for grocery items. Thus, customers can receive customized offers for services or discounts that are more likely to be used by the respective customers, resulting in improved customer traffic at the retail environment and satisfied customers.

In one embodiment, the system 100 can include a graphical user interface (GUI) 126 for displaying the information generated by the system 100 to a user such as a store manager or other employee. In one embodiment, the graphical user interface 126 can be on a personal computer, a mobile smart device, or the like. The graphical user interface 126 can display to the user which customers may be eligible for customized service or discount offers, and the specific service or discount offers that are available. In one embodiment, the graphical user interface 126 can be used to output an electronic report to a user with information regarding which customers may be eligible for customized service or discount offers, and the specific service or discount offers that are available.

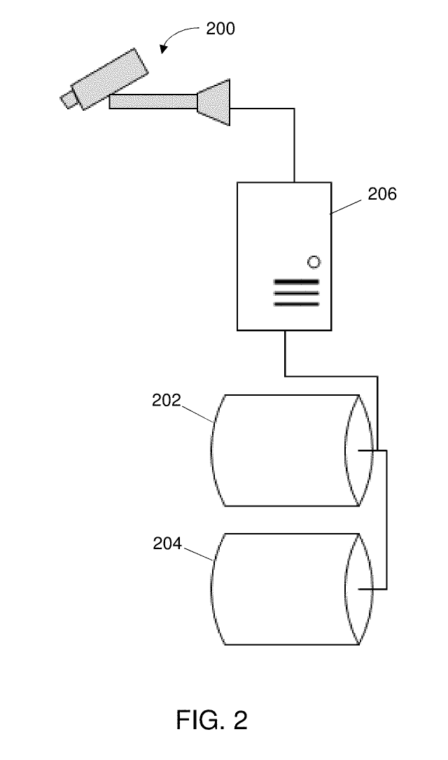

FIG. 2 is a block diagram of an exemplary implementation of a sensor 200 of the system 100. The sensor 200 can be in the form of one or more video cameras communicatively connected to a geographic database 202 and a vehicle database 204 via server 206. As discussed above, one or more sensors 200 can be disposed around the geographic area associated with the retail environment, such as entrance/exit points to a parking lot, a drive-thru window for a pharmacy, entrance/exit points to a gas station, or the like.

The processing device 108 can actuate the sensors 200 to measure the suspension load values associated with vehicles traveling to and from the retail environment, as well as to obtain other vehicle information. The measured data can be electronically stored in the databases 202, 204. For example, data relating the layout or location of the sensors 200 can be stored in the geographic database 202. As a further example, data relating to the vehicles identified in the geographic area and data measured by the sensors 200 can be stored in the vehicle database 204.

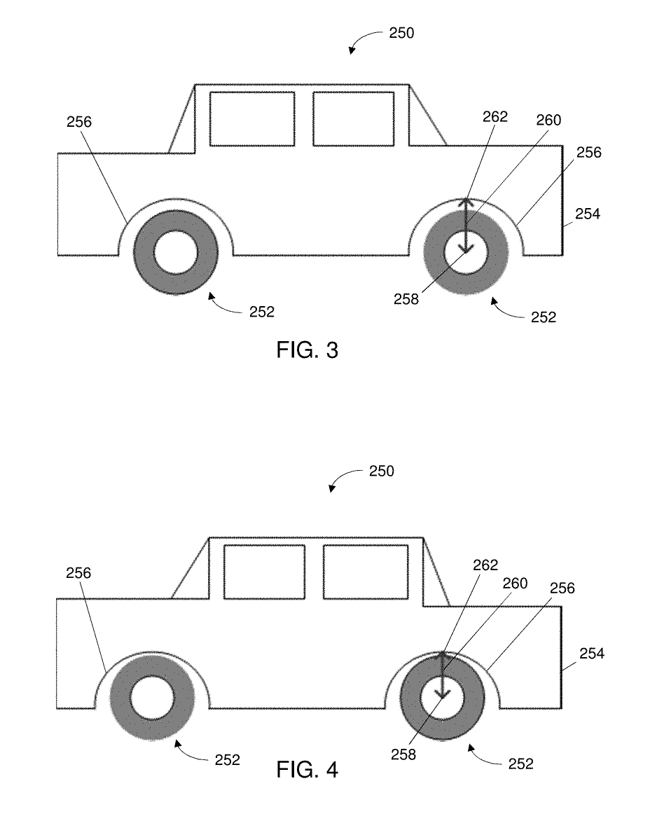

FIGS. 3 and 4 are diagrams of an exemplary measurement of the entry and exit suspension loads of a vehicle 250 with the one or more sensors 102 of the system 100. Although illustrated as having four wheels 252, it should be understood that the system 100 can measure the entry and exit suspension loads in vehicles having any number of wheels 252. The vehicle 250 generally includes a body 254 with openings 256 formed in the body 254 to accommodate each of the respective wheels 252.

The entry and exit suspension load measurements can be performed by measuring a distance from the wheel 252 of the vehicle to the opening 256 in the body 254 of the vehicle 250. In particular, the distance can be measured from a center 258 of the wheel 252 to a top 260 of the opening 256. For example, in FIG. 3, the distance 262 represents the measured value indicative of the entry suspension load of the vehicle 250 prior to purchasing items at the retail environment. As a further example, in FIG. 4, the distance 264 represents the measured value indicative of the exit suspension load of the vehicle 250 after purchasing items at the retail environment.

As can be seen in FIGS. 3 and 4, the distance 264 of the exit suspension load is smaller than the distance 262 of the entry suspension load, indicating that the weight within the vehicle 250 has changed due to one or more items purchased at the retail environment. In particular, the smaller distance 264 indicates that a higher suspension load exists at the time of exit from the retail environment. It should be understood that the sensors 102 measure the entry and exit suspension loads relative to the same wheel 252 of the vehicle 250 for analysis. For example, the entry and exit suspension load measurements that are analyzed can be obtained at the right, front wheel 252. In one embodiment, entry and exit suspension load measurements of two or more wheels 252 of the vehicle 250 can be obtained. In such embodiments, the processing device 108 can analyze the measurements according to the respective wheels to determine the weight distribution at each wheel at the time of entry and exit into the geographic area.

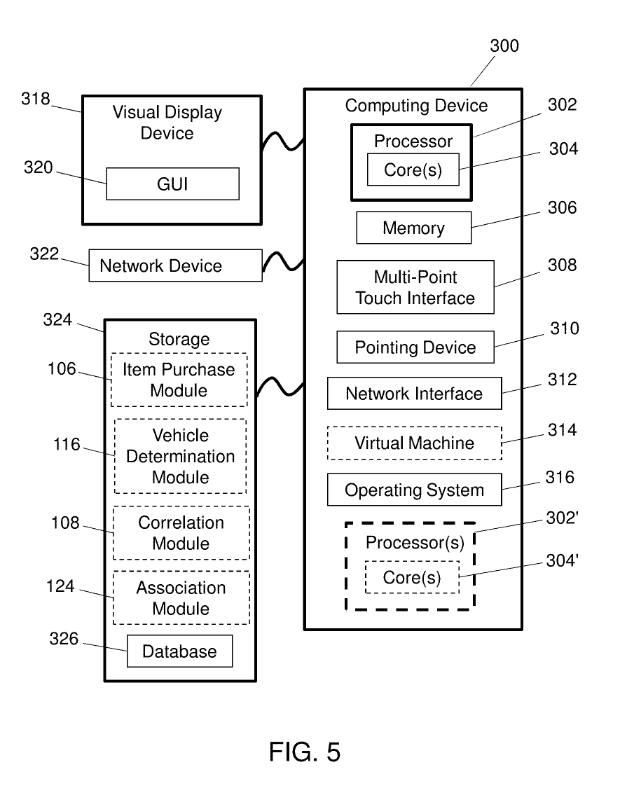

FIG. 5 is a block diagram of a computing device 300 in accordance with exemplary embodiments of the present disclosure. The computing device 300 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 306 included in the computing device 300 may store computer-readable and computer-executable instructions or software for implementing exemplary embodiments of the present disclosure (e.g., instructions for executing the item purchase module 106, the vehicle determination module 116, the correlation module 118, the association module 124, combinations thereof, or the like). The computing device 300 also includes configurable and/or programmable processor 302 and associated core 304, and optionally, one or more additional configurable and/or programmable processor(s) 302′ and associated core(s) 304′ (for example, in the case of computer systems having multiple processors/cores), for executing computer-readable and computer-executable instructions or software stored in the memory 306 and other programs for controlling system hardware. Processor 302 and processor(s) 302′ may each be a single core processor or multiple core (304 and 304′) processor.

Virtualization may be employed in the computing device 300 so that infrastructure and resources in the computing device 300 may be shared dynamically. A virtual machine 314 may be provided to handle a process running on multiple processors so that the process appears to be using only one computing resource rather than multiple computing resources. Multiple virtual machines may also be used with one processor.

Memory 306 may include a computer system memory or random access memory, such as DRAM, SRAM, EDO RAM, and the like. Memory 306 may include other types of memory as well, or combinations thereof.

A user may interact with the computing device 300 through a visual display device 318 (e.g., a personal computer, a mobile smart device, or the like), such as a computer monitor, which may display one or more user interfaces 320 (e.g., GUI 126) that may be provided in accordance with exemplary embodiments. The computing device 300 may include other I/O devices for receiving input from a user, for example, a keyboard or any suitable multi-point touch interface 308, a pointing device 310 (e.g., a mouse). The keyboard 308 and the pointing device 310 may be coupled to the visual display device 318. The computing device 300 may include other suitable conventional I/O peripherals.

The computing device 300 may also include one or more storage devices 324, such as a hard-drive, CD-ROM, or other computer readable media, for storing data and computer-readable instructions and/or software that implement exemplary embodiments of the item purchase module 106, the vehicle determination module 116, the correlation module 118, the association module 124, combinations thereof, or the like, described herein. Exemplary storage device 324 may also store one or more databases 326 for storing any suitable information required to implement exemplary embodiments. For example, exemplary storage device 324 can store one or more databases 326 for storing information, such as data relating to the geographic information 120, the vehicle information 122, or the like, and computer-readable instructions and/or software that implement exemplary embodiments described herein. The databases 326 may be updated by manually or automatically at any suitable time to add, delete, and/or update one or more items in the databases.

The computing device 300 can include a network interface 312 configured to interface via one or more network devices 322 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 312 may include a built-in network adapter, network interface card, PCMCIA network card, card bus network adapter, wireless network adapter, USB network adapter, modem or any other device suitable for interfacing the computing device 300 to any type of network capable of communication and performing the operations described herein. Moreover, the computing device 300 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 300 may run an operating system 316, such as of the versions of the Microsoft® Windows® operating systems, the different releases of the Unix and Linux operating systems, versions of the MacOS® for Macintosh computers, embedded operating systems, real-time operating systems, open source operating systems, proprietary operating systems, or other operating systems capable of running on the computing device and performing the operations described herein. In exemplary embodiments, the operating system 316 may be run in native mode or emulated mode. In an exemplary embodiment, the operating system 316 may be run on one or more cloud machine instances.

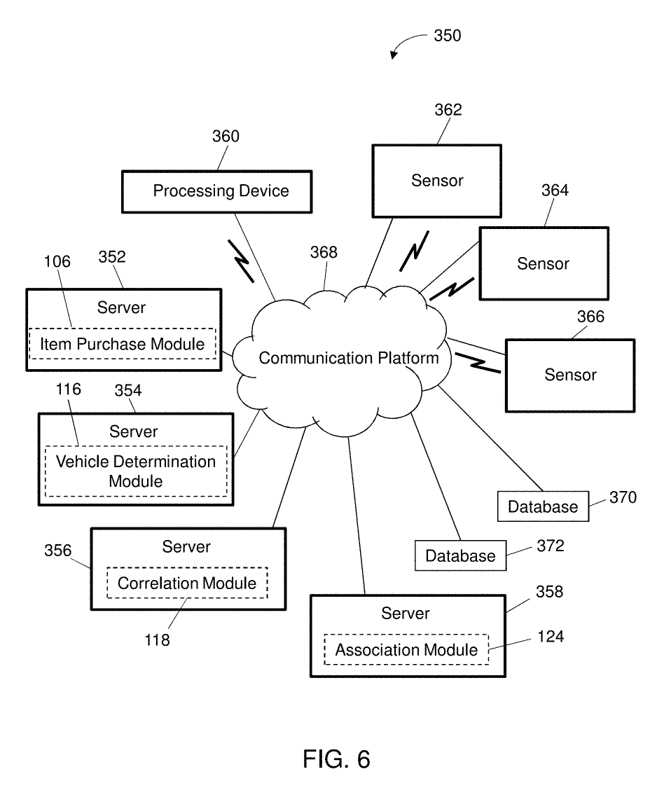

FIG. 6 is a block diagram of an exemplary vehicle suspension measurement system environment 350 in accordance with exemplary embodiments of the present disclosure. The environment 350 can include servers 352, 354, 356, 358 operatively coupled to a processing device 360, and sensors 362, 364, 366, via a communication platform 368, which can be any network over which information can be transmitted between devices communicatively coupled to the network. For example, the communication platform 368 can be the Internet, Intranet, virtual private network (VPN), wide area network (WAN), local area network (LAN), and the like. In one embodiment, the communication platform 368 can be part of a cloud environment. The environment 350 can include repositories or databases 370, 372, which can be operatively coupled to the servers 352, 354, 356, 358, as well as to the processing device 360 and the sensors 362, 364, 366, via the communications platform 368. In exemplary embodiments, the servers 352, 354, 356, 358, processing device 360, sensors 362, 364, 366, and databases 370, 372 can be implemented as computing devices (e.g., computing device 300). Those skilled in the art will recognize that the databases 370, 372 can be incorporated into one or more of the servers 352, 354, 356, 358 such that one or more of the servers 352, 354, 356, 358 can include databases 370, 372. In one embodiment, the database 370 can store the geographic information 120, and the database 372 can store the vehicle information 122. In one embodiment, a single database 370, 372 can store both the geographic information 120 and the vehicle information 122.

In one embodiment, the servers 352, 354, 356, 358 can be configured to implement one or more portions of the system 100. For example, server 352 can be configured to implement one or more portions of the item purchase module 106. As a further example, server 354 can be configured to implement one or more portions of the vehicle determination module 116. As a further example, the server 356 can be configured to implement one or more portions of the correlation module 118. As a further example, the server 358 can be configured to implement one or more portions of the association module 124.

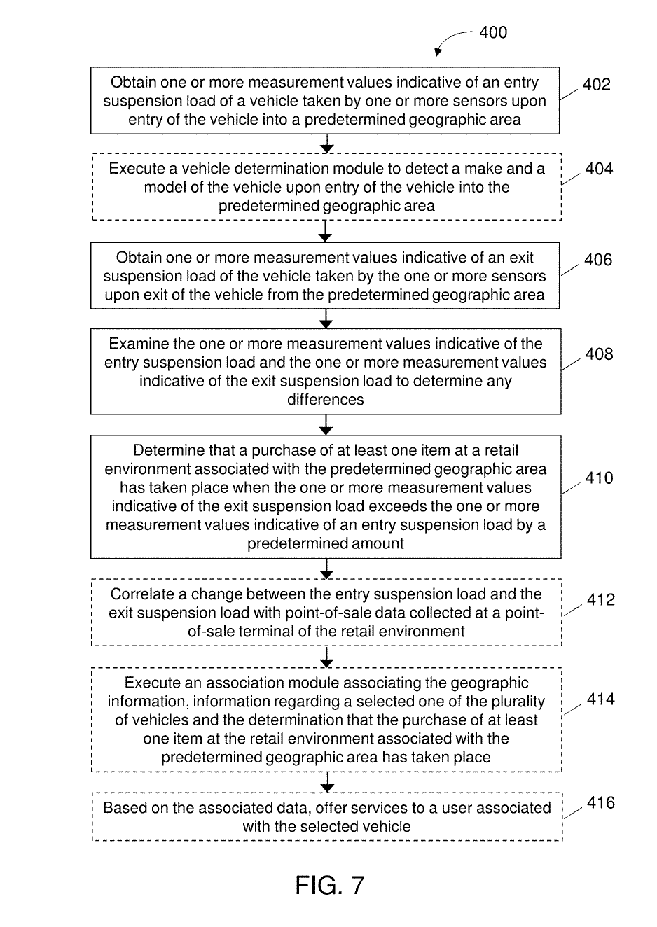

FIG. 7 is a flowchart illustrating an exemplary process 400 as implemented by the vehicle suspension measurement system 100. To begin, at step 402, one or more measurement values indicative of an entry suspension load of a vehicle taken by one or more sensors upon entry of the vehicle into a predetermined geographic area can be obtained. Optionally, at step 404, a vehicle determination module can be executed to detect a make and a model of the vehicle (and to capture additional information associated with the vehicle) upon entry of the vehicle into the predetermined geographic area. At step 406, one or more measurement values indicative of an exit suspension load of the vehicle taken by the one or more sensors upon exit of the vehicle from the predetermined geographic area can be obtained.

At step 408, a determination can be made that a purchase of at least one item at a retail environment associated with the predetermined geographic area has taken place when the one or more measurement values indicative of the exit suspension load exceeds the one or more measurement values indicative of an entry suspension load by a predetermined amount. Optionally, at step 412, a change between the entry suspension load and the exit suspension load can be correlated with POS data collected at a POS terminal of the retail environment. Optionally, at step 414, an association module can be executed to associate the geographic information, information regarding a selected one of the vehicles, and the determination that the purchase of at least one item at the retail environment associated with the predetermined geographic area has taken place. Optionally, at step 416, based on the associated data, services (e.g., customized or targeted services) can be offered to a user associated with the selected vehicle.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A vehicle suspension measurement system, comprising:
one or more sensors, the one or more sensors including a camera;
a processing device equipped with a processor; and
a communication interface configured to enable communication between the one or more sensors and the processing device,
wherein the processing device is configured to execute instructions to:
obtain one or more measurement values indicative of an entry suspension load of a vehicle taken by the one or more sensors upon entry of the vehicle into a predetermined geographic area;
obtain one or more measurement values indicative of an exit suspension load of the vehicle taken by the one or more sensors upon exit of the vehicle from the predetermined geographic area;
examine the one or more measurement values indicative of the entry suspension load and the one or more measurement values indicative of the exit suspension load to determine any differences; and
determine that a purchase of at least one item at a retail environment associated with the predetermined geographic area has taken place when the one or more measurement values indicative of the exit suspension load value exceeds the one or more measurement values indicative of the entry suspension load value by a predetermined amount.

2. The system of claim 1, wherein the one or more measurement values indicative of the entry suspension load and the one or more measurement values indicative of the exit suspension load are measured as a distance from a wheel of the vehicle to a wheel opening for the wheel in the body of the vehicle.

3. The system of claim 2, wherein the one or more measurement values indicative of the entry suspension load and the one or more measurement values indicative of the exit suspension load are measured as a distance from a center of the wheel of the vehicle to a top of the wheel opening for the wheel in the body of the vehicle.

4. The system of claim 1, wherein the predetermined geographic area is a parking lot associated with the retail environment.

5. The system of claim 1, wherein the predetermined geographic area is at least one of a gas station area, a vehicle repair area, a pharmacy area, a grocery area, or a pick-up area, associated with the retail environment.

6. The system of claim 1, wherein the one or more sensors further include a scale and the processing device is configured to execute instructions to obtain measurements of an entry weight of the vehicle taken by the scale upon entry of the vehicle into the predetermined geographic area.

7. The system of claim 6, wherein the processing device is configured to execute instructions to obtain measurements of an exit weight of the vehicle taken by the scale upon exit of the vehicle from the predetermined geographic area.

8. The system of claim 1, wherein the one or more sensors include a first sensor and a second sensor, and the processing device is configured to execute instructions to obtain measurement values indicative of a first entry suspension load and a first exit suspension load of a first wheel of the vehicle taken by the first sensor and to obtain measurement values indicative of a second entry suspension load and a second exit suspension load of a second wheel of the vehicle taken by the second sensor.

9. The system of claim 8, wherein the one or more sensors include a third sensor and a fourth sensor, and the processing device is configured to execute instructions to obtain measurement values indicative of a third entry suspension load and a third exit suspension load of a third wheel of the vehicle taken by the third sensor and to obtain measurement values indicative of a fourth entry suspension load and a fourth exit suspension load of a fourth wheel of the vehicle taken by the fourth sensor.

10. The system of claim 1, wherein the processing device is configured to execute a vehicle determination module to detect a make and a model of the vehicle upon entry of the vehicle into the predetermined geographic area.

11. The system of claim 1, wherein the processing device is configured to execute instructions to correlate a change between the entry suspension load and the exit suspension load with point-of-sale data collected at a point-of-sale terminal of the retail environment.

12. The system of claim 1, further comprising one or more databases holding geographic information regarding a location of the one or more sensors and information regarding a plurality of vehicles determined to have entered into the predetermined geographic area.

13. The system of claim 12, wherein the processing device executes an association module associating the geographic information, information regarding a selected one of the plurality of vehicles and the determination that the purchase of at least one item at the retail environment associated with the predetermined geographic area has taken place in order to offer services to a user associated with the selected vehicle.

14. A non-transitory computer-readable medium storing instructions for determining a change in suspension load of a vehicle that are executable by a processing device, wherein execution of the instructions by the processing device causes the processing device to:
obtain one or more measurement values indicative of an entry suspension load of a vehicle taken by one or more sensors upon entry of the vehicle into a predetermined geographic area, the one or more sensors including a camera;
obtain one or more measurement values indicative of an exit suspension load of the vehicle taken by the one or more sensors upon exit of the vehicle from the predetermined geographic area;
examine the one or more measurement values indicative of the entry suspension load and the one or more measurement values indicative of the exit suspension load to determine any differences; and
determine that a purchase of at least one item at a retail environment associated with the predetermined geographic area has taken place when the one or more measurement values indicative of the exit suspension load exceeds the one or more measurement values indicative of the entry suspension load by a predetermined amount.

15. The medium of claim 14, wherein the one or more sensors further include a scale, and wherein execution of the instructions by the processing device causes the processing device to obtain measurements of an entry weight of the vehicle taken by the scale upon entry of the vehicle into the predetermined geographic area.

16. The medium of claim 15, wherein execution of the instructions by the processing device causes the processing device to obtain measurements of an exit weight of the vehicle taken by the scale upon exit of the vehicle from the predetermined geographic area.

17. The medium of claim 14, wherein the one or more sensors include a first sensor and a second sensor, and wherein execution of the instructions by the processing device causes the processing device to obtain measurement values indicative of a first entry suspension load and a first exit suspension load of a first wheel of the vehicle taken by the first sensor, and to obtain measurement values indicative of a second entry suspension load and a second exit suspension load of a second wheel of the vehicle taken by the second sensor.

18. The medium of claim 17, wherein the one or more sensors include a third sensor and a fourth sensor, and wherein execution of the instructions by the processing device causes the processing device to obtain measurement values indicative of a third entry suspension load and a third exit suspension load of a third wheel of the vehicle taken by the third sensor, and to obtain measurement values indicative of a fourth entry suspension load and a fourth exit suspension load of a fourth wheel of the vehicle taken by the fourth sensor.

19. The medium of claim 14, wherein execution of the instructions by the processing device causes the processing device to execute a vehicle determination module to detect a make and a model of the vehicle upon entry of the vehicle into the predetermined geographic area.

20. A method of determining a change in suspension load of a vehicle, comprising:
obtaining one or more measurement values indicative of an entry suspension load of a vehicle taken by one or more sensors upon entry of the vehicle into a predetermined geographic area, the one or more sensors including a camera;
obtaining one or more measurement values indicative of an exit suspension load of the vehicle taken by the one or more sensors upon exit of the vehicle from the predetermined geographic area;
examining the one or more measurement values indicative of the entry suspension load and the one or more measurement values indicative of the exit suspension load to determine any differences; and
determining that a purchase of at least one item at a retail environment associated with the predetermined geographic area has taken place when the one or more measurement values indicative of the exit suspension load exceeds the one or more measurement values indicative of the entry suspension load by a predetermined amount.
